(19) United States
(12) Patent Application Publication
(10) Pub. No.: US 2019/0289871 A1
(43) Pub. Date: Sep. 26, 2019

(54) PRE-TEMPERED SAUTEING OIL FOR CONVENIENT SINGLE-USE COOKING

(71) Applicant: BINDU RAMA RAO, LAGUNA NIGUEL, CA (US)

(72) Inventor: BINDU RAMA RAO, LAGUNA NIGUEL, CA (US)

(21) Appl. No.: 15/934,982

(22) Filed: Mar. 24, 2018

(51) Int. Cl. A23D 9/007; A23D 9/04

(52) U.S. Cl. CPC A23D 9/007; A23V 2200/15; A23V 2002/00; A23D 9/04

(57) ABSTRACT

The tempering of a combination of several different spices using only a little bit of oil initially, and subsequently after tempering, mixing it with additional amount of edible oil to generate a sautéing oil of the right strength, flavors and consistency prior to packing for single-use cooking experience are some of the unique aspects of this present invention. A pre-tempered sautéing oil is useful to mix with cooked rice in order to prepare fried rice in South Indian style (a short cut approach to traditional more elaborate process), or mixed with microwaved or pre-cooked vegetables to conveniently and quickly prepare Indian style curry.

### CROSS REFERENCES TO RELATED APPLICATIONS

.

### BACKGROUND

### 1. Technical Field

The present invention relates generally to use of edible oil with spices, and more specifically to a new off-the-shelf preparatory tempered sautéing oil that provides a short-cut and easy means to make curries and sautéed vegetables in the Indian style.

### 2. Related Art

Making use of a whole lot of spices of different kind to make a dish is well known in the art. The complexities of spices and the various flavors they incorporate is daunting to most youngsters (college going and single individuals), especially to most people in the west. This is especially true of Indian cuisine that include a whole lot of spices of different kind. Even many Indians have little ability to buy or stock all those spices especially if they cook at home infrequently for various reasons. In addition, spices and herbs, in general, come in big packets and often a user is reluctant to buy them just to make a dish infrequently that might require their use. A user has to buy a big bottle of spices of various kinds to make an India dish even if the user needs to use less than half a tablespoon of those spices and herbs for that dish. The trouble of buying all those various spices and the expense of buying them to make a single dish is prohibitive quite often even to the initiated. The problem is not just the cost but also the inconvenience involved in buying them and storing them for infrequent use.

South Indians use oil for various purposes when it comes to cooking: tempering, sautéing, stir frying, deep frying, preserving, marinating and pickling. Most of these activities involve the use of several different types of spices and herbs that most individuals are unaware of, especially in the west. Even people in the east are unable and incapable to make flavorfull spicy dishes without having a complete collection of several different types of spices and herbs at home in various bottles and packets. The process of buying and storing all those spices is not only expensive for anyone but also requires a lot of knowledge of flavors, recipes and cooking techniques. Even if one purchases all those spices at great expense, one may not be able to master the techniques required. It is seldom possible to make ethnic food easily and conveniently without buying all those spices, herbs etc.

Indians in particular have been using tempering techniques using several different spices and edible oil in their recipes—tempering is done either at the beginning of the cooking process or as a final flavoring at the end. For example, a typical tempering process might involve the use of peanut oil to which coriander, cumin, cayenne and turmeric is added and heated, and the person cooking has to keep very close watch on the heated contents as it burns easily (and might even be dangerous to the uninitiated) and not only the temperature is critical but also the duration of tempering is extremely critical. Tempering is often just one important step in the process of sautéing vegetables, to make a curry for example. In general tempering is not an easy skill that can be mastered by most non-professional cooks, especially those who cook infrequently.

Similar problems are prevalent with regard to most ethnic cuisine—if one wants to cook such ethnic cuisine, one is forced to buy exotic spices in large quantities at great expense and inconvenience.

The present inventor has discovered a solution to these problems, and by employing the product and methods described below, a typical individual with a desire to make good, tasty and healthy food can discover the short cuts to preparing a great dish without the expenses and inconveniences involved.

Further limitations and disadvantages of conventional and traditional approaches will become apparent to one of ordinary skill in the art through comparison of such systems with the present invention.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a diagram showing an exemplary method of preparing single-use package of pre-tempered sautéing oil.

### DETAILED DESCRIPTION OF THE DRAWINGS

The term “TEMPERED SAUTEING OIL” is intended to refer to all spiced up oil or edible oil based-like preparatory compositions (products of tempering) that incorporate several different types of spices, herbs and condiments typically found in ethnic cuisines such as Indian cuisine, such as asafetida, cumin seeds, chili pepper, black peppers, split black gram greater, mustard seeds and garlic. The term is intended, for example, to include edible oil based preparatory products that are often an intermediary byproduct/step in cooking Indian dishes or Asian dishes. It also is intended to refer to oil based infusions wherein several different types of spices and herbs are included and packaged for use as preparatory material to make ethnic dishes. For example a typical chef would temper a whole lot of spices in edible oil before tossing in vegetables or rice to finish a dish.

The term “PRE-TEMPERED SAUTEING OIL” is intended to refer to ready-to-use, convenient, off-the-shelf sautéing oil product, that when used, makes tempering with spices unnecessary, and subsequent cooking steps very easy, by requiring a simple administration of the pre-tempered sautéing oil over a cooked substrate for a dish to be completed and ready to be eaten. The pre-tempered sautéing oil is good to use right away for sautéing, and is packed in small containers, each container storing about 1 ounce of the pre-tempered sautéing oil that is sufficient to flavor and cook about 1 pound of cooked vegetables or 1 pound of rice. It will not require the user to add any extra spices or any extra oil as it comes completely ready and comprises all the spices and oil needed to make the actual cooking process simple, convenient, easy, quick and cost-effective. The cooked substrate is cooked rice, cooked vegetables or cooked pasta, based on an individual's preferences and food habits. Thus the pre-tempered sautéing oil is a preparatory composition that now comes readymade for mere administration over the cooked substrate (a base item such as cooked rice or cooked vegetables), and available for use without having to purchase and assemble all the spicy ingredients and bottles of edible oil beforehand in preparation or as a first step in cooking.

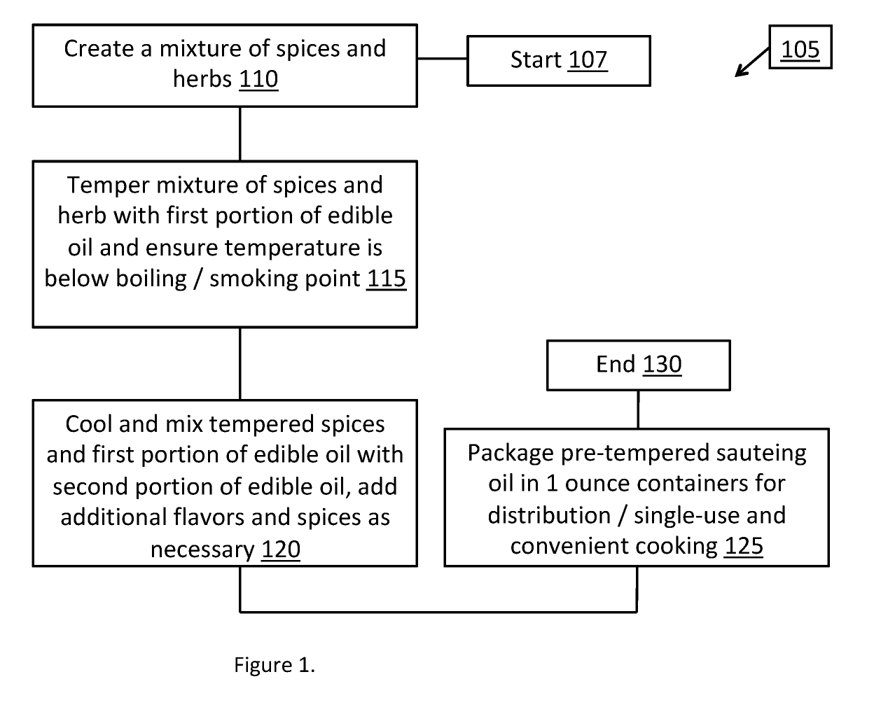

FIG. 1 is a process flow diagram showing an exemplary method of preparing single-use package of pre-tempered sautéing oil. At a block 107, the processing starts when the required ingredients are identified and weighed and the proportion of various ingredients are properly checked/ensured as per a recipe. Then at a next block 110, a mixture of spices and herbs is created. Then at a next block 115, the mixture of spices and herb with a first portion of edible oil is tempered, while ensuring that the first portion of edible oil is heated while making sure it is below boiling/smoking point. Then, at a next block 120, the tempered first portion of edible oil with all those tempered spices and herbs, is cooled, before adding to it the second portion of edible oil, add additional flavors and spices as necessary. Then at a next block 125, the pre-tempered sautéing oil is packaged in single-use (for convenience of use in infrequent cooking or otherwise) containers. For example, it is packaged in 1 ounce containers for distribution/single-use and for convenient cooking without requiring the purchase and storage of different spices and oils. Finally at the end block 130, the process ends.

The present invention makes it possible to employ a short-cut approach to preparing ethnic food dishes such as Indian curries wherein a single-use package of preparatory sautéing oil infusion makes it possible to jumpstart the cooking process easily, cost effectively, and conveniently. Specifically, the expense of acquiring all those spices for infrequent cooking (such as adhoc cooking) by a user wherein only a small amount of spices are needed, while the packet or bottle of spices comes in large quantities that go to waste essentially after a simple single cooking event, is avoided under the present invention. The same savings and convenience is applicable for the edible oils needed for cooking, for the herbs needed, etc. Thus, in accordance to the present invention, a prepared small single-use amount of edible oil with tempered spices and herbs provide the ease of use, the cost effectiveness, the convenience in assembling a complicated dish, etc.

The tempering of a combination of several different spices using only a little bit of oil initially, and subsequently after tempering, mixing it with additional amount of edible oil to generate a sautéing oil of the right strength, flavors and consistency prior to packing for single-use cooking experience are some of the unique aspects of this present invention.

In one embodiment, the tempered sautéing oil of the invention is prepared combining edible oil such as peanut oil or olive oil, preferably tempered with asafoetida, cumin seeds, split black gram, mustard seeds and turmeric. In some combinations, powered coriander, cloves and cinnamon are also added prior to tempering in oil. In some other combinations, these are added to the tempered mixture of spices after the tempering process. In other combinations, peanuts and curry leaves (Murraya koenigii) are also added to the tempering process—such a tempered sautéing oil is useful to mix with cooked rice in order to prepare fried rice in South Indian style (a short cut approach to traditional more elaborate process).

In this way basic preparations are obtained by tempering, to which additional edible oil of the same type used in tempering or edible oil of a different type, such as one with lower boiling point, is added in different combinations, along with salt or others flavors optionally, to obtain other desired tastes, consistency and texture. For example, peanut oil that has a relatively higher boiling point is used for tempering with the spices and herbs, and subsequently extra virgin olive oil (for health benefits or for other reasons) is mixed in to make the right proportion of edible oil so that the sautéing oil is prepared with the right strength, viscosity etc. for packaging and distribution.

The finished product, in the appearance of a pre-tempered sautéing oil, is therefore composed by one or more edible oils, as a main ingredient, combined with spices of different kind such as cloves, pepper, cinnamon, coriander, turmeric, garlic, split black gram, asafetida, sugar as needed, and optionally enhanced by addition of herbs such as curry leaves. The finished product is made available in single-use containers by packaging them using sachets or small leak-proof disposable bottles.

A one ounce container/sachet/bottle of pre-tempered sautéing oil created in accordance with the present invention is typically sufficient to flavor and sauté about 1 pound of cooked vegetables (or one pound of cooked rice) which amounts to about 4 servings of about 100 grams each. This invention is not limited to one-ounce containers of pre-tempered sautéing oil. Smaller containers of pre-tempered sautéing oil sufficient to prepare 2 servings of sauted vegetables are contemplated. Similarly, larger containers of pre-tempered sautéing oil sufficient to prepare 6 and 8 servings of sauted vegetables are also contemplated.

In one embodiment, the pre-tempered sauté oil is usable for sautéing cooked pasta, and is tempered using basil, rosemary, onions, and garlic. The pre-tempered sauté oil may contain at least 0-40% balsamic vinegar along with sugars, modified starches and xanthan gum. Such a pre-tempered sauté oil can be administered over cooked pasta to provide an instant shortcut pasta with all the required spices and flavors.

Here some examples are given of basic preparations, of the pre-tempered sautéing oil realized in accordance with the invention.

### Basic Preparations

### Example 1 with Asafoetida

the pre-tempered sautéing oil comprises:
the edible oil of greater than 70 wt. % up to about 90 wt. %;
asafoetida greater than 0 wt. % up to 1 wt. %;
turmeric powder greater than 0 wt. % up to 1 wt. %;
cumin seeds greater than 0 wt. % and up to 3 wt. %;
chili pepper greater than 0 wt. % and up to 3 wt. %;
split black gram greater than 0 wt. % and up to 3 wt. %; and
mustard seeds greater than 0 wt. % and up to 3 wt. %;

### Example 2 with Garlic

the pre-tempered sautéing oil comprises:
   the edible oil of greater than 70 wt. % up to about 90 wt. %;
   garlic greater than 0 wt. % up to 1 wt. %;
   turmeric powder greater than 0 wt. % up to 1 wt. %;
   cumin seeds greater than 0 wt. % and up to 3 wt. %;
   chili pepper greater than 0 wt. % and up to 3 wt. %;
   split black gram greater than 0 wt. % and up to 3 wt. %; and
   mustard seeds greater than 0 wt. % and up to 3 wt. %;
      Other combinations of spices is contemplated too, using different kind of herbs, targeted to create Indian curries with different precooked vegetables. Some combinations are aimed towards administration over cooked rice to generate short-cut fried rice.

The pre-tempered sautéing oil is perfect for convenient off-the-shelf single-use cooking, with no need to buy spices in large bottles and store them at home when one cooks infrequently. In one embodiment, the pre-tempered sautéing oil comprises an edible oil of greater than 70 wt. % up to about 90 wt. %, asafoetida greater than 0 wt. % up to 1 wt. %, turmeric powder greater than 0 wt. % up to 1 wt. %, cumin seeds greater than 0 wt. % and up to 3 wt. %, chili pepper greater than 0 wt. % and up to 3 wt. %, split black gram greater than 0 wt. % and up to 3 wt. %, and mustard seeds greater than 0 wt. % and up to 3 wt. %. The pre-tempered sautéing oil is prepared by a method in which a first subset of the edible oil is mixed and tempered with the asafoetida, cumin seeds, chili pepper, split black gram and the mustard seeds by heating it to a temperature just below the boiling point of the edible oil until the mustard seeds start to pop (or, for example, for a fixed timed duration), and subsequently mixed with the rest of the edible oil before packaging for single-use into one or more one ounce disposable containers, wherein the disposable containers are each one of a sachet or a leak-proof bottle.

One advantage of the present invention is that pre-tempered sautéing oil can be sold commercially in small containers such as sachets and leak-proof bottles for purchase by individuals who want to cook at home without the inconvenience of having to shop for a plethora of expensive and exotic hard-to-get spices. The ability to obtain pre-tempered sautéing oil is a great time-saving and cost-effective aspect of the present invention, for convenient off-the-shelf single-use cooking, especially for those who only cook infrequently and do not want to stock up on all those spices.

In a related embodiment, the pre-tempered sautéing oil uses garlic—the asafoetida is replaced by garlic. This is often favored by people who do not like asafetida and prefer garlic.

There is an advantage to tempering the oil using only a subset of edible oil called for, so that the reduced volume of liquid mixed with spices and herbs would be not only easier to handle and transport as necessary, but also provide the opportunity to employ more than one type of edible oil. For example, the pre-tempered sautéing oil can be divided into two subsets or portions at the beginning, wherein the first subset of the edible oil is one of coconut oil, canola oil and peanut oil that have a relatively higher boiling temperature and the rest of the edible oil is one of olive oil and ghee. Thus tempering only uses edible oil of higher boiling point to which other types of edible oil and subsequently added after tempering of spices to derive the necessary flavors or health benefits. In a related embodiment of the pre-tempered sautéing oil, one or more herbs such as curry leaves, rosemary, basil and oregano are also tempered with the first subset of the edible oil.

A method of preparing a pre-tempered sautéing oil comprises mixing a first portion of an edible oil with asafoetida, cumin seeds, chili pepper, split black gram and the mustard seeds, and tempering by heating it to a temperature just below the boiling point of the edible oil for a fixed duration or selectively until the cumin seeds pop, to prepare a first tempered portion. It also comprises a subsequent step of adding a second portion of the edible oil to the first tempered portion to create the final pre-tempered sautéing oil. The pre-tempered sautéing oil comprises the following when it is all prepared:
a. the edible oil of greater than 70 wt. % up to about 90 wt. %;
b. asafoetida greater than 0 wt. % up to 1 wt. %;
c. turmeric powder greater than 0 wt. % up to 1 wt. %;
d. cumin seeds greater than 0 wt. % and up to 3 wt. %;
e. chili pepper greater than 0 wt. % and up to 3 wt. %;
f. split black gram greater than 0 wt. % and up to 3 wt. %; and
g. mustard seeds greater than 0 wt. % and up to 3 wt. %;

The method also comprises packaging the pre-tempered sautéing oil after it is prepared into one or more one ounce disposable containers, wherein the one ounce disposable containers are one of a sachet or a leak-proof bottle. The individual wanting to cook can use one of the one ounce disposable containers to quickly and conveniently cook a curry by just administrating the pre-tempered sautéing oil over cooked vegetables and sautéing them over a heat source briefly until done. For example, the pre-tempered sautéing oil thus prepared is useable to cook an Indian vegetable curry by administering it over a semicooked or microwaved vegetable and sautéing briefly over a heat source.

In a related embodiment, the tempering of the first portion of the edible oil with the other ingredients occurs at a selected range of temperature, wherein said selected range of temperature is between 350 degree F. and 420 degree F. In addition, the second portion of the edible oil is added to the first tempered portion at room temperature after the tempering of the first portion of the edible oil with the spices etc. One or more of the following is also added to the first portion of an edible oil to prepare the first tempered portion in some embodiments—diced garlic, black pepper and dried fenugreek seeds.

In general, a spicy oil infusion for use in cooking Indian vegetable curry in a short-cut and convenient process is also created in accordance with the present invention. The spicy oil infusion comprises the following:
a. an edible oil of greater than 70 wt. % up to about 90 wt. %,
b. asafoetida greater than 0 wt. % up to 1 wt. %,
c. cumin seeds greater than 0 wt. % and up to 3 wt. %,
d. chili pepper greater than 0 wt. % and up to 3 wt. %,
e. split Black gram greater than 0 wt. % and up to 3 wt. %,
f. mustard seeds greater than 0 wt. % and up to 3 wt. %,

The spicy oil infusion is prepared by mixing a first subset of the edible oil with the asafoetida, cumin seeds, chili pepper, split black gram and the mustard seeds and pre-tempering it by heating it to a temperature just below the boiling point of the edible oil until the cumin seeds pop. It is then mixed with the rest of the edible oil. By doing so, the first subset of the edible oil is full of flavor albeit in a concentrated form, and likely to be strong and would require dilution before packaging. Thus it is mixed with the rest of the edible oil and subsequently the mixed edible oil is packaged for commercial off-the-shelf distribution into one or more one ounce disposable single-use containers, wherein the disposable containers are one of a sachet or a leak-proof bottle.

In a related embodiment, one or more of diced garlic, black pepper and dried fenugreek seeds are also used during tempering process. In addition, the heating of the first subset of the edible oil mixed with the other ingredients occurs at a selected range of temperature, wherein said selected range of temperature is between 350 degree F. and 410 degree F. based on the boiling or smoking point of the edible oil employed. The final product, the prepared single-use sachet or bottle of the spicy oil infusion is now useable not only for cooking Indian curries when administered over precooked or microwaved vegetables, but also useable in producing Indian fried rice when administered and stirred over cooked rice. It is important to note that the selected temperature range is likely to vary based on the type of edible oil used for the tempering of the spices—for example, it could be in the range of 380 degree F. to 450 degree F. for some edible oils that have a relatively much higher boiling or smoking point.

Although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A pre-tempered sautéing oil for convenient off-the-shelf single-use cooking, the pre-tempered sautéing oil comprising:
an edible oil of greater than 70 wt. % up to about 90 wt. %;
asafoetida greater than 0 wt. % up to 1 wt. %;
turmeric powder greater than 0 wt. % up to 1 wt. %;
cumin seeds greater than 0 wt. % and up to 3 wt. %;
chili pepper greater than 0 wt. % and up to 3 wt. %;
split black gram greater than 0 wt. % and up to 3 wt. %;
mustard seeds greater than 0 wt. % and up to 3 wt. %;
wherein the pre-tempered sautéing oil is prepared by mixing a first subset of the edible oil and tempering it with the asafoetida, cumin seeds, chili pepper, split black gram and the mustard seeds by heating it to a temperature just below the boiling point of the edible oil until the mustard seeds start to pop, and subsequently mixing with the rest of the edible oil before packaging for single-use off-the-shelf distribution and storage into one or more one ounce disposable containers, wherein the disposable containers are each one of a sachet or a leak-proof bottle.

2. The pre-tempered sautéing oil of claim 1 wherein the asafoetida is replaced by garlic.

3. The pre-tempered sautéing oil of claim 1 wherein the first subset of the edible oil is one of coconut oil, canola oil and peanut oil that have a relatively higher boiling temperature and the rest of the edible oil is one of olive oil and ghee.

4. The pre-tempered sautéing oil of claim 1 further comprising:
herbs that are also tempered with the first subset of the edible oil, wherein the herbs are one of curry leaves, basil and coriander leaves.

5. A method of preparing a pre-tempered sautéing oil for off-the-shelf use, the method comprising:
mixing a first portion of an edible oil with asafoetida, cumin seeds, chili pepper, split black gram and the mustard seeds, and tempering by heating it to a temperature just below the boiling point of the edible oil for a fixed duration or selectively until the cumin seeds pop, to prepare a first tempered portion;
adding a second portion of the edible oil to the first tempered portion to create the sautéing oil infusion so as to create the right flavors, consistency and health benefits;
wherein the pre-tempered sautéing oil comprises:
the edible oil of greater than 70 wt. % up to about 90 wt. %;
asafoetida greater than 0 wt. % up to 1 wt. %;
turmeric powder greater than 0 wt. % up to 1 wt. %;
cumin seeds greater than 0 wt. % and up to 3 wt. %;
chili pepper greater than 0 wt. % and up to 3 wt. %;
split black gram greater than 0 wt. % and up to 3 wt. %; and
mustard seeds greater than 0 wt. % and up to 3 wt. %;
packaging the pre-tempered sautéing oil into one or more one ounce disposable containers that is distributable commercially for off-the-shelf usage, wherein the one ounce disposable containers are one of a sachet or a leak-proof bottle; and
wherein the pre-tempered sautéing oil thus prepared is useable to cook an Indian vegetable curry by administering it over a semicooked or microwaved vegetable and sautéing briefly over a heat source.

6. The method of claim 5 wherein the tempering of the first portion of the edible oil with the other ingredients occurs at a selected range of temperature, wherein said selected range of temperature is between 350 degree F. and 420 degree F.

7. The method of claim 6 wherein the second portion of the edible oil is added to the first tempered portion at room temperature.

8. The method of claim 5 wherein one or more of the following is also added to the first portion of an edible oil to prepare the first tempered portion:
one or more of diced garlic, cinnamon, nutmeg, black pepper and dried fenugreek seeds.

9. A spicy oil infusion for use as off-the-shelf preparatory ingredient in producing Indian vegetable curry, the spicy oil infusion comprising:
an edible oil of greater than 70 wt. % up to about 90 wt. %,
asafoetida greater than 0 wt. % up to 1 wt. %,
cumin seeds greater than 0 wt. % and up to 3 wt. %,
chili pepper greater than 0 wt. % and up to 3 wt. %,
split Black gram greater than 0 wt. % and up to 3 wt. %,
mustard seeds greater than 0 wt. % and up to 3 wt. %,
wherein the spicy oil infusion is prepared by mixing a first subset of the edible oil with the asafoetida, cumin seeds, chili pepper, split black gram and the mustard seeds and pre-tempering it by heating it to a temperature just below the boiling point of the edible oil until the cumin seeds pop; and
mixing, the first subset of the edible oil with the rest of the edible oil and subsequently packaging the mixed edible oil into one or more one ounce disposable single-use containers, wherein the disposable containers are one of a sachet or a leak-proof bottle.

10. The spicy oil infusion of claim 9 further comprising:
one or more of diced garlic, black pepper, cinnamon, nutmeg and dried fenugreek seeds.

11. The spicy oil infusion of claim 9 wherein the heating of the first subset of the edible oil mixed with the other ingredients occurs at a selected range of temperature, wherein said selected range of temperature is between 350 degree F. and 410 degree F. based on the boiling point of the edible oil employed.

12. The spicy oil infusion of claim 9 wherein the spicy oil infusion is also useable in producing Indian fried rice when administered and stirred over cooked rice.

13. The spicy oil infusion of claim 9 wherein the spicy oil infusion is also useable in producing sautéed pasta when administered and stirred over cooked pasta.
